(19) United States
(12) Patent Application Publication
(10) Pub. No.: US 2026/0050421 A1
(43) Pub. Date: Feb. 19, 2026

(54) OPTIMIZATION DEVICE, OPTIMIZATION METHOD, AND A RECORDING MEDIUM

(71) Applicant: NEC Corporation, Tokyo (JP)

(72) Inventors: Koji ICHIKAWA, Tokyo (JP); Yu KIYOKAWA, Tokyo (JP)

(73) Assignee: NEC Corporation, Tokyo (JP)

(21) Appl. No.: 19/285,003

(22) Filed: Jul. 30, 2025

(30) Foreign Application Priority Data
Aug. 15, 2024 (JP) 2024-135663

(51) Int. Cl. G06F 8/35; G06F 8/70

(52) U.S. Cl. CPC G06F 8/35; G06F 8/70

(57) ABSTRACT

In an optimization device, an input information acquisition means acquires input information regarding a problem input by a user. A code generation means generates a code based on the input information, A program execution means executes a program based on the code and acquiring a solution. An output means outputs the solution.

### INCORPORATION BY REFERENCE

This application is based upon and claims the benefit of priority from Japanese Patent Application 2024-135663, filed on Aug. 15, 2024, the disclosure of which is incorporated herein in its entirety by reference.

### TECHNICAL FIELD

The present disclosure relates to a technology of mathematical optimization.

### BACKGROUND ART

Industries incorporate mathematical optimization into their business to solve various problems in operation of organizations, such as resource allocation, cost reduction, revenue maximization, and productivity improvement. In order to use the mathematical optimization in the business, mathematical experts in the industries apply the mathematical optimization to intended business. In a case where the mathematical optimization is not used, many decisions are made by the experts only with knowledge, and therefore, incorporating the mathematical optimization into the business for sustainable decision making and determination has attracted attention. The following Patent document 1 describes a method of solving an optimization problem by calling an optimization solver machine that generates a solution for the optimization problem based on a user input.
Patent Document 1: Japanese Patent Application Laid-Open under No. JP JP 2021-2331

### SUMMARY

However, when the mathematical optimization is applied, it is needed to solve a business problem using specialized knowledge of each domain and knowledge of the mathematical optimization, and it takes time. Since a reporting ability is also needed in addition to the specialized knowledge of each domain and the knowledge of the mathematical optimization, there has been a problem that it is often difficult to introduce the mathematical optimization into the business. In consultation in which the mathematical optimization is performed as the business, there has also been a problem that the application of the mathematical optimization is difficult to spread to a market since a time taken for a person in charge of the business to solve a problem and the number of problems in charge are limited.

One object of the present disclosure is to support a user who does not have specialized knowledge of a domain or knowledge of mathematical optimization to solve a business problem using the mathematical optimization.

In order to solve the above problem, according to an example aspect of the present invention, there is provided an optimization device comprising:
input information acquisition means for acquiring input information regarding a problem input by a user;
code generation means for generating a code based on the input information;
program execution means for executing a program based on the code and acquiring a solution; and
output means for outputting the solution.

According to another example aspect of the present invention, there is provided an optimization method executed by an optimization device, the optimization method comprising:
acquiring input information regarding a problem input by a user;
generating a code based on the input information;
executing a program based on the code and acquiring a solution; and
outputting the solution.

According to still another example aspect of the present invention, there is provided a program for causing a computer to execute processing comprising: acquiring input information regarding a problem input by a user;
generating a code based on the input information;
executing a program based on the code and acquiring a solution; and
outputting the solution.

### Effect

According to the present disclosure, it is possible to support a user who does not have specialized knowledge of a domain or knowledge of mathematical optimization to solve a business problem using the mathematical optimization.

### BRIEF DESCRIPTION OF THE DRAWINGS

FIG. 1 illustrates an example of a schematic configuration of an optimization system;

FIGS. 2A and 2B illustrate examples of hardware configurations of a server and a user terminal;

FIG. 3 is a block diagram illustrating an example of a functional configuration of the server;

FIG. 4 is an example of a problem input screen;

FIGS. 5A and 5B are examples of a prompt and an output result in a problem processing unit;

FIG. 6 is an example of an additional input screen;

FIGS. 7A and 7B are examples of a prompt and an output result in a modeling processing unit;

FIG. 8 is an example of a template of a prompt to request conversion into a code;

FIGS. 9A and 9B are examples of a prompt and an output result in a coding processing unit;

FIG. 10 is a sample code example when an error occurs;

FIG. 11 is an example of a template of a prompt to request a report;

FIG. 12 is an example of a prompt in a reporting processing unit;

FIG. 13 is an example of an output result in the reporting processing unit; and

FIG. 14 is a flowchart of optimization processing.

### EXAMPLE EMBODIMENTS

Preferred example embodiments of the present disclosure will be described with reference to the accompanying drawings.

### EXAMPLE EMBODIMENT

### (Configuration)

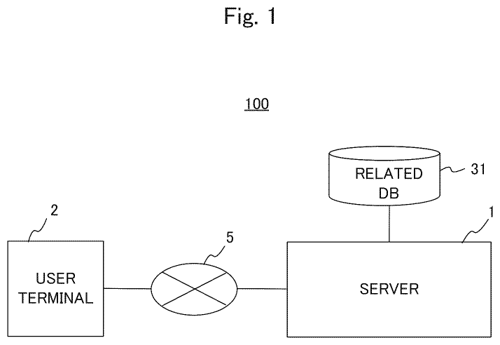

FIG. 1 is an example of a schematic configuration of an optimization system 100 to which an optimization device of the present disclosure is applied. The optimization system 100 is a system that supports a user who does not have specialized knowledge of a domain or knowledge of mathematical optimization to solve a business problem using the mathematical optimization.

Here, the mathematical optimization is a process of finding a value of an optimal objective function under a specific constraint condition. The value of the optimal objective function may be a value of a maximum or minimum objective function. There are many methods for the mathematical optimization, such as a linear programming problem, a non-linear programming problem, an integer programming problem, combinatorial optimization, black-box optimization, and optimization using a machine learning model.

Domain knowledge is knowledge in a field specialized in a certain specialized field, and there are a wide variety of domains that may handle the mathematical optimization, such as manufacturing industry, distribution industry/transportation industry, financial industry, energy, public transportation, healthcare, and retail industry. For example, in the manufacturing industry, the mathematical optimization can be applied to optimization of manufacturing processes, resource allocation, production planning, inventory management, supply chain management, and the like.

In the optimization system 100, a server 1 and a user terminal 2 are communicably connected via a network 5 such as the Internet. The user terminal 2 is a tablet, a personal computer (PC), or the like used by a user who intends to solve a business problem using the mathematical optimization, and transmits information input by the user to the server 1.

The server 1 is an information processing device that processes, stores, and transmits/receives various types of data, and automates a business process for applying the mathematical optimization based on information input by a user (hereinafter, also referred to as “user input information”). Specifically, based on the user input information, the server 1 performs problem definition for knowing an outline of a problem to be solved such as a business problem, construction of a mathematical optimization model (hereinafter, also referred to as a “mathematical model”), model implementation, and reporting of a result. Here, the model implementation is assumed to include coding for converting the mathematical model into a code and solving for executing a program based on the code to acquire a solution.

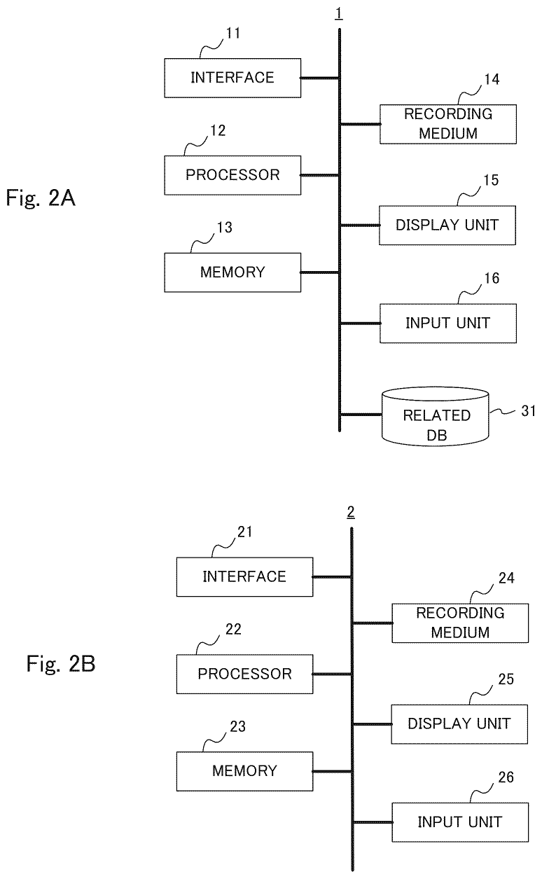

FIG. 2A is a block diagram illustrating an example of a hardware configuration of the server 1. As illustrated, the server 1 includes an interface (Interface) 11, a processor 12, a memory 13, a recording medium 14, a display unit 15, and an input unit 16. These components and a related database (DB) 31 are connected to each other via a bus.

The interface 11 exchanges data with the user terminal 2. The interface 11 is used when receiving user input information from the user terminal 2. The interface 11 is also used when the server 1 exchanges data with a predetermined device connected in a wired or wireless manner. The interface 11 is also used when the server 1 acquires web information such as the Internet.

The processor 12 is a computer such as a central processing unit (CPU), and controls the entire server 1 by executing a program prepared in advance. As the processor 12, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like can be used.

The memory 13 includes a read only memory (ROM), a random access memory (RAM), or the like. The memory 13 stores a program executed by the processor 12. The memory 13 is also used as a working memory during execution of various types of processing by the processor 12.

The recording medium 14 is a non-volatile and non-transitory recording medium such as a disk-shaped recording medium or a semiconductor memory, and is attachable to and detachable from the server 1. The recording medium 14 records various programs executed by the processor 12. When the server 1 executes optimization processing, the program recorded in the recording medium 14 is loaded into the memory 13 and executed by the processor 12.

The display unit 15 displays a predetermined image by, for example, a liquid crystal display (LCD). The input unit 16 is a keyboard, a mouse, a touch panel, or the like, and is used by an operator who manages the server 1.

As will be described in detail later, the related DB 31 stores and manages information related to problem definition, construction of a mathematical model, model implementation, and reporting of a result, which are business processes for applying the mathematical optimization.

FIG. 2B is a block diagram illustrating an example of a hardware configuration of the user terminal 2. As illustrated, the user terminal 2 includes an interface 21, a processor 22, a memory 23, a recording medium 24, a display unit 25, and an input unit 26.

The interface 21 exchanges data with the server 1 via the network 5. The interface 21 is used to transmit the user input information to the server 1 and receive various types of information from the server 1.

The processor 22 is a computer such as a CPU, and controls the entire user terminal 2 by executing a program prepared in advance. As the processor 22, a CPU, a GPU, a DSP, an MPU, an FPU, a PPU, a TPU, a quantum processor, a microcontroller, or a combination of these can be used.

The memory 23 includes a ROM, a RAM, or the like. The memory 23 stores a program executed by the processor 22. The memory 23 is also used as a working memory during execution of various types of processing by the processor 22.

The recording medium 24 is a non-volatile and non-transitory recording medium such as a disk-shaped recording medium or a semiconductor memory, and is attachable to and detachable from the user terminal 2. The recording medium 24 records various programs executed by the processor 22. The display unit 25 displays a predetermined image by, for example, an LCD. The input unit 26 is a touch panel or the like, and is used when a user performs a predetermined operation.

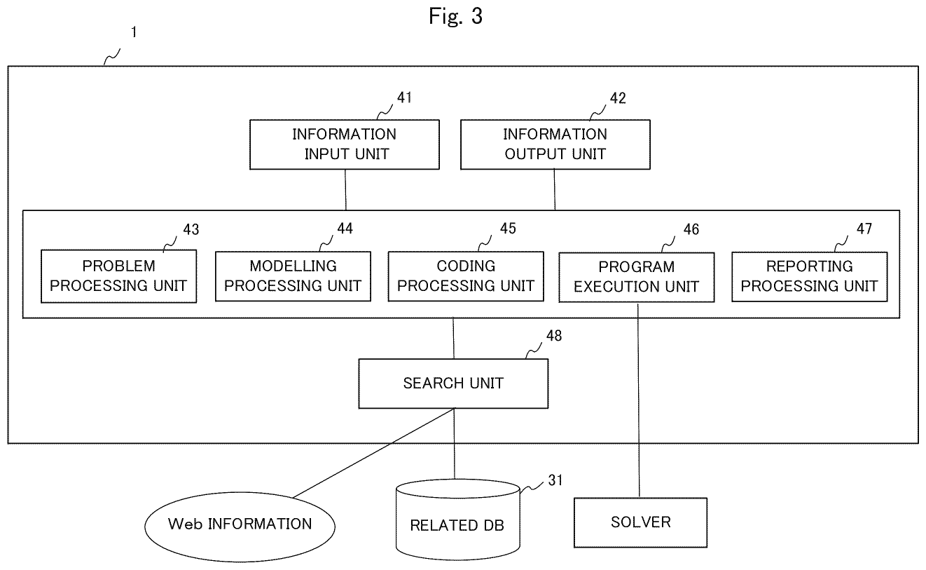

FIG. 3 is a block diagram illustrating an example of a functional configuration of the server 1. The server 1 functionally includes an information input unit 41, an information output unit 42, a problem processing unit 43, a modeling processing unit 44, a coding processing unit 45, a program execution unit 46, a reporting processing unit 47, and a search unit 48. The information input unit 41, the information output unit 42, the problem processing unit 43, the modeling processing unit 44, the coding processing unit 45, the program execution unit 46, the reporting processing unit 47, and the search unit 48 are achieved by the processor 12 executing a program.

Processing of the problem processing unit 43, the modeling processing unit 44, the coding processing unit 45, and the reporting processing unit 47 is achieved by generative artificial intelligence (AI). Specifically, the generative AI is large language models (LLM) capable of understanding multi-modal information. In the present example embodiment, the processing of the problem processing unit 43, the modeling processing unit 44, the coding processing unit 45, and the reporting processing unit 47 is achieved by the generative AI. However, the present disclosure is not limited to this. For example, for an input sentence, a related sentence, a case, and a method in a DB may be searched using vectorization by keyword or sentence embedding, or a desired output may be obtained by combining language models specific to tasks such as summary, question answering (QA), and information extraction.

The information input unit 41 acquires user input information regarding a content of a problem desired to be solved such as a business problem of what is desired to be optimized in business. As the user input information, for example, a form of text, audio, a figure, a table, various documents, or a combination of these is assumed. The user input information may be, for example, in an interactive format such as e-mail text, meeting minutes, or audio data of a hearing between a user who intends to solve a business problem using the mathematical optimization and a consultant who performs the mathematical optimization as business.

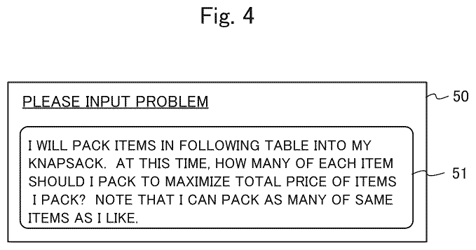

FIG. 4 is an example of a problem input screen displayed on the user terminal 2. As illustrated in FIG. 4, a problem input screen 50 includes, for example, a message prompting input such as “Please input a problem” and an input item 51 to which a problem such as a business problem desired to be solved by a user is input.

In a case where it is desired to solve the business problem using the mathematical optimization, the user causes the user terminal 2 to display the problem input screen as illustrated in FIG. 4 by a predetermined operation. For example, the user then inputs, to the input item 51, a content of the problem desired to be solved by text, such as “I will pack items in the following table into my knapsack. At this time, how many of each item should I pack to maximize a total price of the items I pack? Note that I can pack as many of the same items as I like.”. The information input unit 41 acquires information input to the input item 51 from the user terminal 2 as the user input information.

The information output unit 42 outputs various types of information generated by the problem processing unit 43, the modeling processing unit 44, the coding processing unit 45, the program execution unit 46, and the reporting processing unit 47.

The problem processing unit 43 recognizes an outline of a problem to be solved based on the user input information regarding the problem, and clarifies an object, specifies a variable, and specifies a constraint condition, and as a result, generates information needed for constructing a mathematical model (hereinafter, also referred to as “modeling”), such as the object, a constraint, data, and a decision variable, and outputs the listed information. For example, the clarification of the object is to clarify what is desired to be optimized in the problem, such as cost reduction, revenue maximization, and time reduction. The specification of the variable specifies a variable for which an optimal value is desired to be found as a result of optimization, and for example, specifies a decision variable or an instrumental variable in the problem. The specification of the constraint condition is to clarify a constraint related to the problem. Examples of the constraint related to the problem include resource limitation, a time constraint, and a legal requirement. For convenience, the information needed for constructing the mathematical model, such as the object, the constraint, the data, and the decision variable is also referred to as “problem definition information”.

The problem processing unit 43 may collectively output a problem and information such as a business process related to the problem in such a way that a user can confirm an output content and can easily perform feedback by the user. The user may also specify, to the generative AI, a format of the output such as itemization, figures, tables, and various documents.

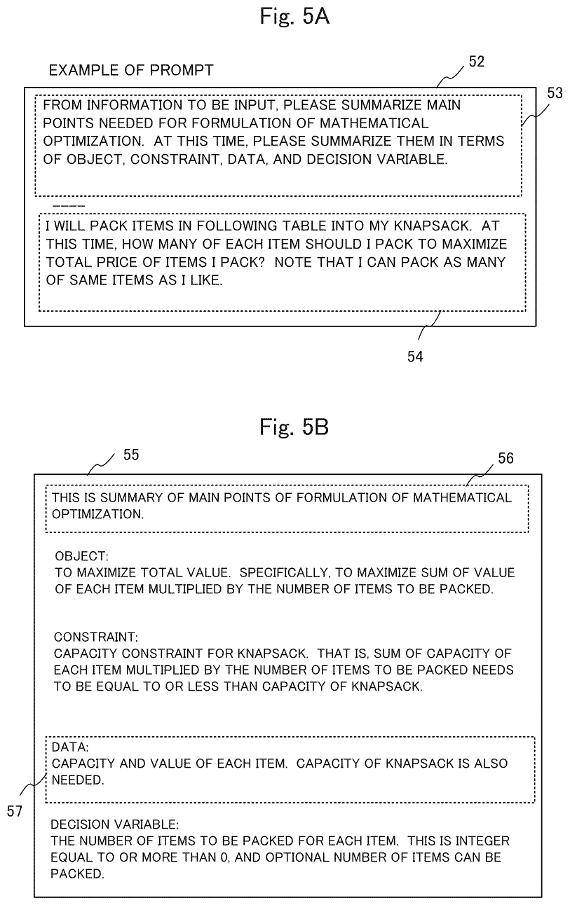

Specifically, the problem processing unit 43 can be achieved by inputting a prompt to request generation of the problem definition information to the generative AI based on the user input information. Here, the generative AI is the LLM and accepts, for example, text and various forms other than text, such as GPT-4 (registered trademark), Claude (registered trademark), and Gemini. The generative AI can apply, for example, various forms of data such as text, audio, figures, tables, various documents, or a combination of these. FIG. 5A is an example of the prompt input to the generative AI in the problem processing unit 43. As illustrated in FIG. 5A, a prompt 52 includes an instruction 53 to summarize main points needed for formulation of the mathematical optimization, and a content 54 of a problem input by a user.

The main points needed for the formulation of the mathematical optimization are main points needed for constructing a mathematical model. The prompt is not limited to this, and can be optionally set as long as it is an instruction to request generation of problem definition information needed for constructing the mathematical model. Accuracy of the formulation may be increased by giving an example of input/output as the prompt.

FIG. 5B is an example of an output result of the generative AI. When the prompt as illustrated in FIG. 5A is input to the generative AI, an output result 55 illustrated in FIG. 5B is output. As illustrated in FIG. 5B, the output result 55 includes a message 56 “This is a summary of the main points of the formulation of the mathematical optimization.”, an object, a constraint, main points of a decision variable, and a message 57 pointing out insufficient data. The output result of the generative AI is transmitted to the user terminal 2 by the information output unit 42 and displayed. As a result, the user can confirm a content of the output result 55 output by the generative AI. As illustrated in FIG. 5B, the output result includes an instruction to add information to the user when the information is insufficient. That is, for the user who cannot successfully input the problem to be solved, the server 1 can prompt the user to input in a question and answer format to collect information needed. The input in the question and answer format can be applied not only to the problem processing unit 43 but also to the modeling processing unit 44, the coding processing unit 45, and the reporting processing unit 47 described later.

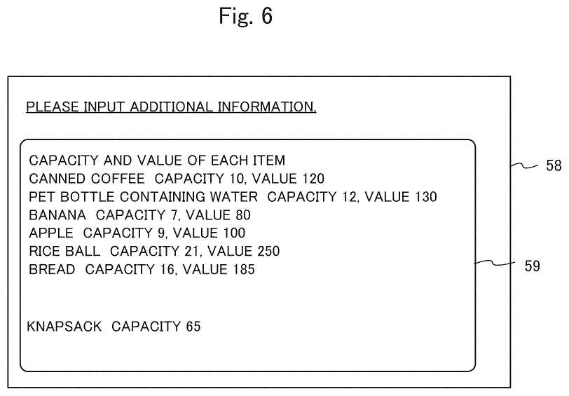

FIG. 6 is an example of an additional input screen 58. As illustrated in FIG. 6, the additional input screen 58 includes, for example, a message prompting input of additional information such as “Please input additional information” and an additional item 59 to which the additional information is input. In a case where the additional information is input, the user causes the user terminal 2 to display the additional input screen as illustrated in FIG. 6 by a predetermined operation. The additional information is information desired to be added by the user who has confirmed the content of the output result 55, and is correction, additional information, or the like. For example, in the additional item 59, the user inputs a content of the data pointed out to be insufficient in text. The information input unit 41 acquires the additional information input to the additional item 59 from the user terminal 2 as new user input information. The additional information is reflected in various types of processing as necessary. For example, the problem processing unit 43 may perform processing of generating problem definition information in response to a new prompt reflecting the additional information, or the modeling processing unit 44 described later may perform processing of generating a mathematical model in response to a prompt reflecting the additional information.

In a case where there is no additional information by the user and the user agrees with the content of the output result by the generative AI, the user agrees with the content of the output result by a predetermined operation, and agreement information is transmitted from the user terminal 2 to the server 1. The information input unit 41 acquires the agreement information from the user terminal 2 as new user input information.

For the clarification of the object, the specification of the variable, and the specification of the constraint condition, the related DB 31 in which past user input information and problem definition information generated based on the past user input information are stored in association with each other may be prepared in advance. In this case, the problem processing unit 43 searches for similar user input information in the related DB 31 via the search unit 48, and refers to related problem definition information. Specifically, the problem processing unit 43 can improve performance by, for example, inputting a pair of the similar user input information and problem definition information as an example in a prompt of the generative AI. According to such a related DB 31, new information is accumulated each time of use, and accuracy of generating the problem definition information can be enhanced. The problem processing unit 43 may refer to related information such as web information or a paper for the clarification of the object, the specification of the variable, and the specification of the constraint condition.

After confirming the content of the output result by the generative AI, the user may appropriately point out an excess or deficiency point or an error as the additional information, to improve quality of the output result. For example, as a feedback after the output content is confirmed, a question such as “What is considered to be insufficient for modeling?” may be performed on the generative AI, and as a result, the user can input insufficient information pointed out from the generative AI.

The modeling processing unit 44 constructs and outputs a mathematical model based on the problem definition information and the user input information generated by the problem processing unit 43. Specifically, when the user agrees with a content of an output result by the problem processing unit 43, the modeling processing unit 44 forms an objective function and converts a constraint condition into a mathematical expression based on the problem definition information, and formulates the problem into the mathematical model. That is, the mathematical model is constructed by expressing the objective function, a decision variable, the constraint condition, and parameters in various expressions as a mathematical format of the objective function of the mathematical optimization. For example, in a case where it is possible to express the objective function to be minimized in a format of “f”, the decision variable in a format of “x”, and the constraint condition in a format of “g(x)>=0”, the mathematical model of the problem is formulated as “minf(x) s.t., g(x)>=0”.

In the present example embodiment, the mathematical model is formulated by forming the objective function and converting the constraint condition into the mathematical expression. However, the present disclosure is not limited to this, and the mathematical model may be formulated by generating an expression having the same value or the same information as the objective function and the constraint condition.

The modeling processing unit 44 formulates the problem into the mathematical model by selecting an appropriate optimization method, but may cause a solution method of the mathematical model to be output as necessary. This outputs a policy on how to solve the problem. Specifically, for example, the modeling processing unit 44 selects an optimal method for solving the problem from linear programming, non-linear programming, integer programming, mixed integer programming, Bayesian optimization, simulated annealing, heuristic, and the like based on specification of the problem such as linear, non-linear, or discrete. The modeling processing unit 44 outputs the selected method and a solver when the method is adopted as the solution method. Examples of the solver include Gurobi and Optuna. The modeling processing unit 44 may output, as the solution method, a type of the problem such as a traveling salesman problem, a knapsack problem, or a facility location problem, and a policy of efficient formulation such as variable definition and problem division.

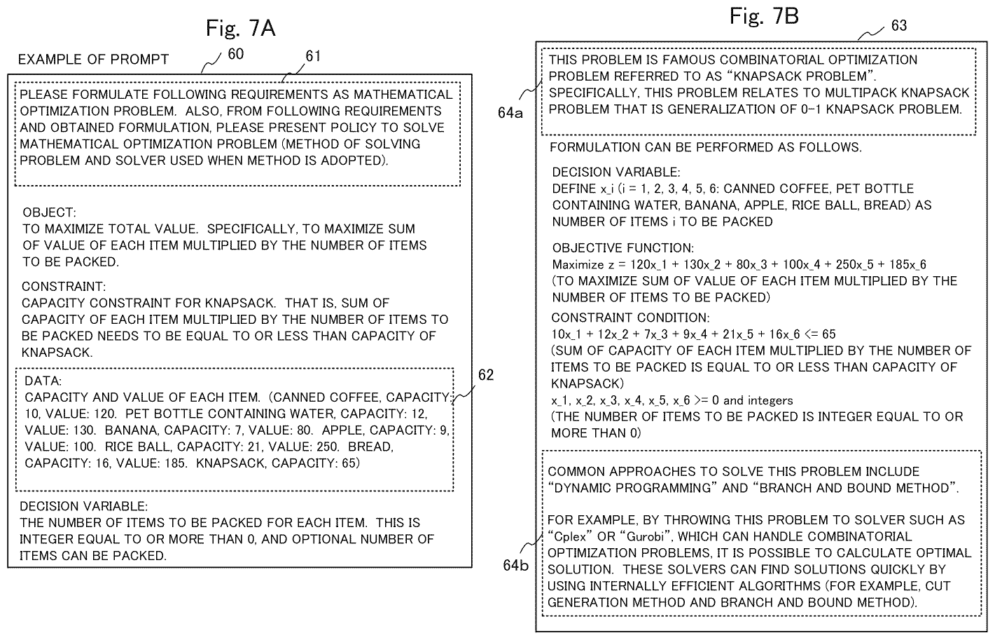

Specifically, the modeling processing unit 44 can be achieved by inputting a prompt to request the formulation of the mathematical model to the generative AI based on the problem definition information and the user input information generated by the problem processing unit 43. FIG. 7A is an example of the prompt input to the generative AI in the modeling processing unit 44. As illustrated in FIG. 7A, a prompt 60 includes an instruction 61 to formulate the mathematical model and obtain the solution method of the mathematical model, an object, a constraint, and a decision variable taken from the problem definition information generated by the problem processing unit 43, and a content 62 of the additional information input by the user. The prompt is not limited to include the instruction 61 as long as a formulated expression or a desirable policy can be obtained, and can be optionally set. Accuracy of the formulation may be increased by giving an example of input/output as the prompt. Regarding the formulation of the mathematical model, the output may be more easily understood by giving a rule as a prompt for a symbol of a variable to be used.

FIG. 7B is an example of the output result of the generative AI in the modeling processing unit 44. When the prompt as illustrated in FIG. 7A is input to the generative AI, an output result 63 illustrated in FIG. 7B is output. As illustrated in FIG. 7B, the output result 63 includes a message “Formulation can be performed as follows.”, the decision variable, the objective function, and the constraint condition converted into the mathematical expression, a message 64a describing a type of the problem, and a message 64b indicating an optimal method for solving the problem and a solver when the method is adopted. The output result of the generative AI is transmitted to the user terminal 2 by the information output unit 42 and displayed. As a result, the user can confirm a content of the output result 63 by the generative AI. The user may input the additional information from the additional input screen 58 as necessary. In a case where there is no additional information by the user and the user agrees with the content of the output result by the modeling processing unit 44, the user transmits agreement information from the user terminal 2 to the server 1 by a predetermined operation. The information input unit 41 acquires the agreement information from the user terminal 2 as new user input information.

Information in which a past problem and a solution method related to the past problem are associated with each other may be stored in the related DB 31. In this case, the modeling processing unit 44 searches for a similar problem in the related DB 31 via the search unit 48, and refers to a related solution method. Specifically, the modeling processing unit 44 can improve performance by, for example, inputting a pair of the similar problem and solution method as an example in a prompt of the generative AI. The modeling processing unit 44 may refer to related information such as web information or a paper in order to formulate the mathematical model.

After confirming the content of the output result by the generative AI, the user may appropriately point out an excess or deficiency point or an error as the additional information, to improve quality of the output result.

The coding processing unit 45 converts a mathematical model into a code. Specifically, when the user agrees with a content of an output result by the modeling processing unit 44, the coding processing unit 45 generates and outputs a programming code based on problem definition information generated by the problem processing unit 43 and the mathematical model formulated by the modeling processing unit 44.

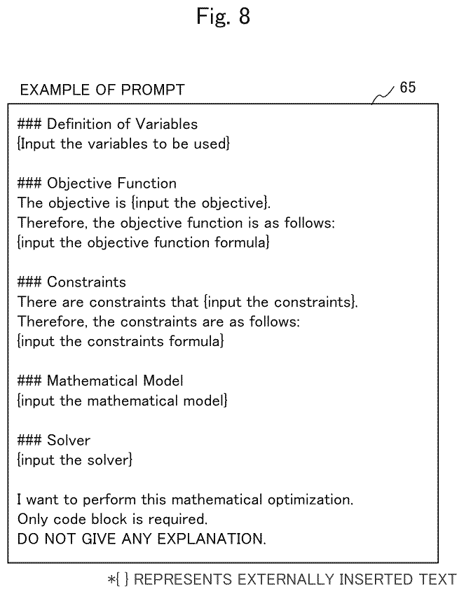

Specifically, the coding processing unit 45 can be achieved by inputting a prompt to request conversion into a code to the generative AI based on the problem definition information generated by the problem processing unit 43, and an objective function, limitation information converted into a mathematical expression, and the formulated mathematical model generated by the modeling processing unit 44. FIG. 8 is an example of a template of the prompt. In curly braces illustrated in FIG. 8, text is inserted that is taken from the problem definition information generated by the problem processing unit 43, and the variable definition, the objective function, the limitation information converted into the mathematical expression, the formulated mathematical model, and a solution method generated by the modeling processing unit 44. Note that, in the prompt 65, the formulated mathematical model is like a summary and is not necessarily needed, and only the variable definition, the objective function, and the limitation information converted into the mathematical expression may be taken. In addition, an input/output example of a past case may be included at an end of the prompt by using “Example”. As the prompt, a solver to be used may be specified, or a solver to be used in a search or the like may be selected in advance.

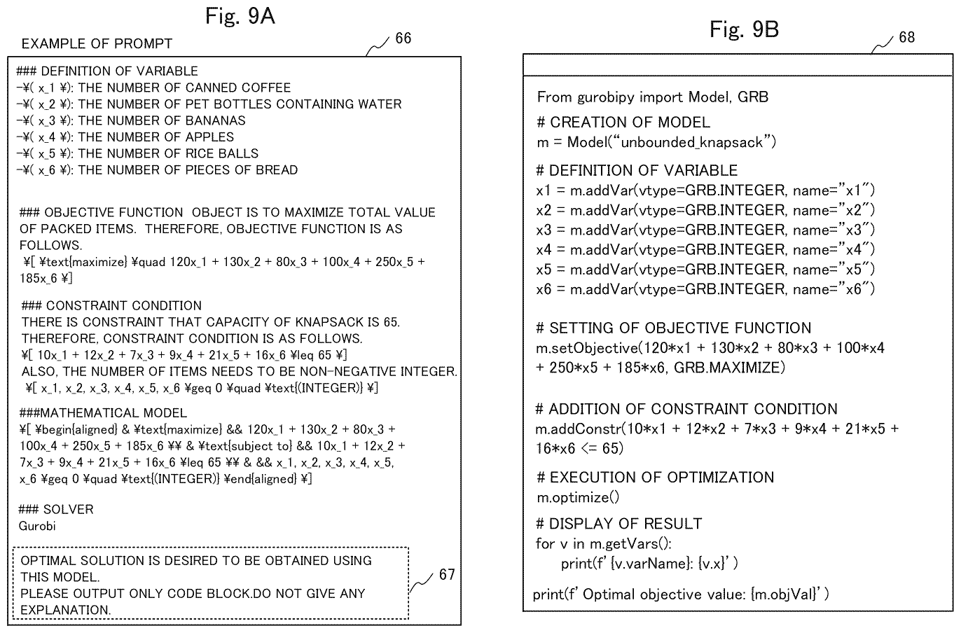

FIG. 9A is an example of the prompt input to the generative AI in the coding processing unit 45. As illustrated in FIG. 9A, a prompt 66 takes the objective function, the limitation information converted into the mathematical expression, and the formulated mathematical model generated by the coding processing unit 45 into a predetermined template, and specifies the solver to be used. The prompt 66 includes an instruction 67 to generate a programming code.

FIG. 9B is an example of the output result of the generative AI in the coding processing unit 45. When the prompt as illustrated in FIG. 9A is input to the generative AI, an output result 68 illustrated in FIG. 9B is output. The output result 68 is a programming code for processing the mathematical model by a computer. The server 1 may transmit the output result 68 to the user terminal 2 to cause the user to confirm the programming code. In this case, by associating definition of a variable and a comment between the programming codes as illustrated in FIG. 9B, the user can easily confirm a content.

Information in which a similar problem, problem definition information, formulated mathematical model, and the like are associated with a related programming code having been executed in the past and a solver to be used may be stored in the related DB 31. In this case, the coding processing unit 45 searches for the similar problem, problem definition information, formulated mathematical model, and the like in the related DB 31 via the search unit 48, and refers to the related programming code or solver. Specifically, the coding processing unit 45 can improve performance by, for example, inputting a pair of the similar problem, problem definition information, formulated mathematical model, and the like, and the programming code and the solver as an example in a prompt of the generative AI. As a result, new information is accumulated each time of use of the related DB 31, and accuracy of generating the programming code can be enhanced.

The program execution unit 46 executes a program based on a generated programming code using a related solver, and outputs a solution as an execution result. Specifically, the program execution unit 46 writes the generated programming code to a file, and executes the program in a programming language such as Python (registered trademark). At this time, the program execution unit 46 executes the program using mathematical optimization software such as MATLAB (registered trademark), Excel Solver, Gurobi (registered trademark), CPLEX (registered trademark), or optimization software executable on a quantum computer, and acquires a solution of a mathematical model. The program execution unit 46 determines whether the acquired solution is applicable to an actual problem, and adjusts the formulated mathematical model as necessary.

The execution result of the program is transmitted to the user terminal 2 by the information output unit 42 and displayed. As a result, a user can confirm an optimal solution of a problem as a content of the execution result. The user may input the additional information from the additional input screen 58 as necessary. In a case where there is no additional information by the user and the user agrees with the content of the execution result of the program, the user transmits agreement information from the user terminal 2 to the server 1 by a predetermined operation. The information input unit 41 acquires the agreement information from the user terminal 2 as new user input information.

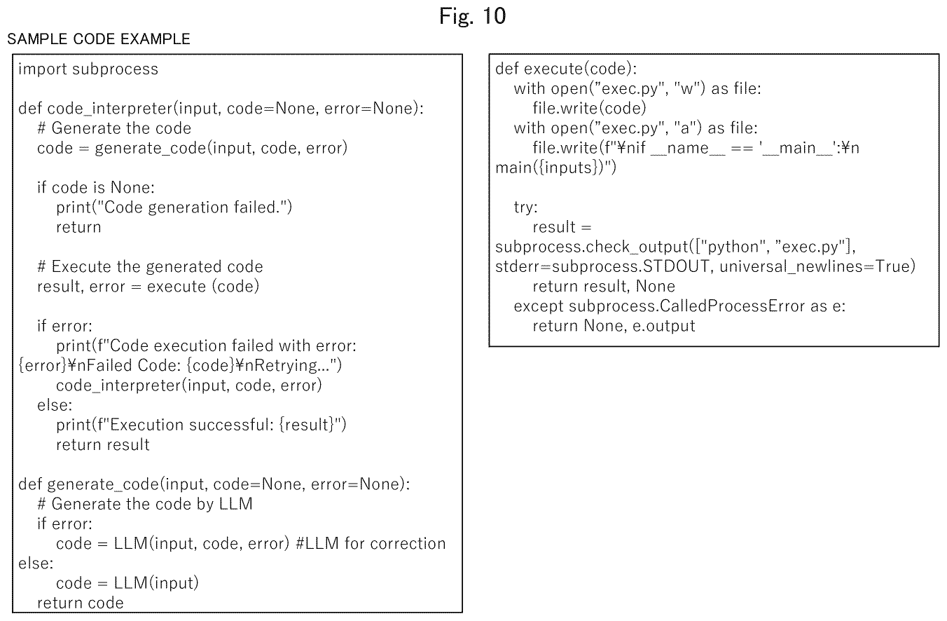

In a case where an error occurs or a solution is not detected during the execution of the program, the program execution unit 46 automatically corrects the program. Specifically, the program execution unit 46 corrects the programming code or corrects the mathematical model based on one or more return values of an execution log and code execution. In other words, the program execution unit 46 can acquire the corrected programming code based on an error message at the time of the execution and the executed programming code. FIG. 10 is a sample code example when the error occurs during the execution of the program. The coding processing unit 45 can acquire the corrected programming code by combining sample codes and appropriately taking in the error message at the time of the execution and the executed programming code.

The reporting processing unit 47 generates and outputs a report with explanation that can be interpreted by a user based on a solution acquired by the program execution unit 46, the user input information, the problem definition information, and the like. In other words, the reporting processing unit 47 adds information to a numerical solution obtained by executing the mathematical optimization by programming based on domain knowledge and the user input information, and generates a summarized result as the report. The report is not limited to text, and can be displayed as text, a mathematical expression, a numerical value, an image, a moving image, audio, or a combination of these. Specifically, the reporting processing unit 47 can be achieved by inputting a prompt to request the report to the generative AI based on the solution or the user input information.

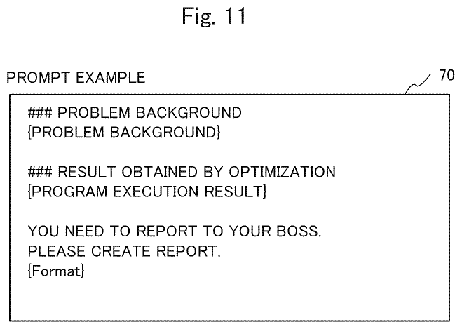

FIG. 11 is an example of a template of the prompt. As illustrated in FIG. 11, a problem background and a program execution result are inserted into curly braces of a prompt 70. As the problem background, it is sufficient that information needed for reporting is input, but in addition, information regarding clarification of an object, specification of a variable, and specification of constraint information may be input, or a business background of the user, motivation of the user to work on a problem, or a request content from a business instructor such as a boss may be input as additional information. As the program execution result, at least a solution acquired by the program execution unit 46 is input as an optimal solution, but description of a solving constraint condition or the like may also be input as the additional information.

For example, the prompt 70 illustrated in FIG. 11 has an instruction to request creation of a report after presenting a report object, such as “You need to report to your boss. Please create a report”. However, the present disclosure is not limited to this, and the instruction can optionally set information as long as the information is needed for reporting. A format of the report may be set by inserting the format into the third curly braces of the prompt 70.

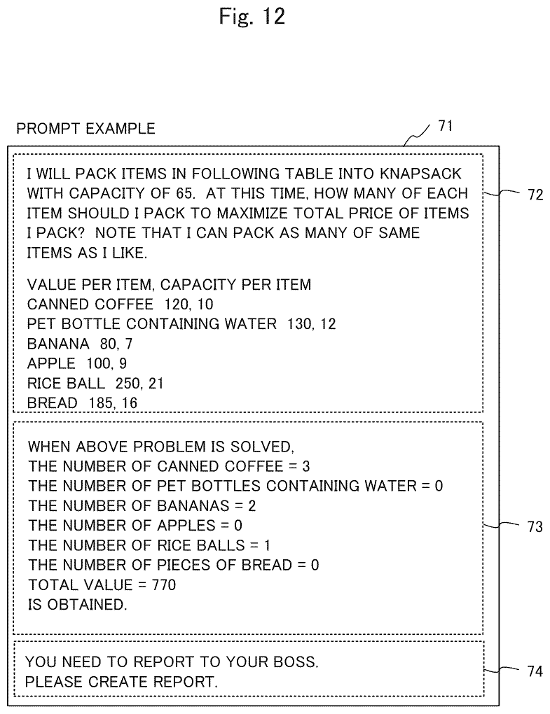

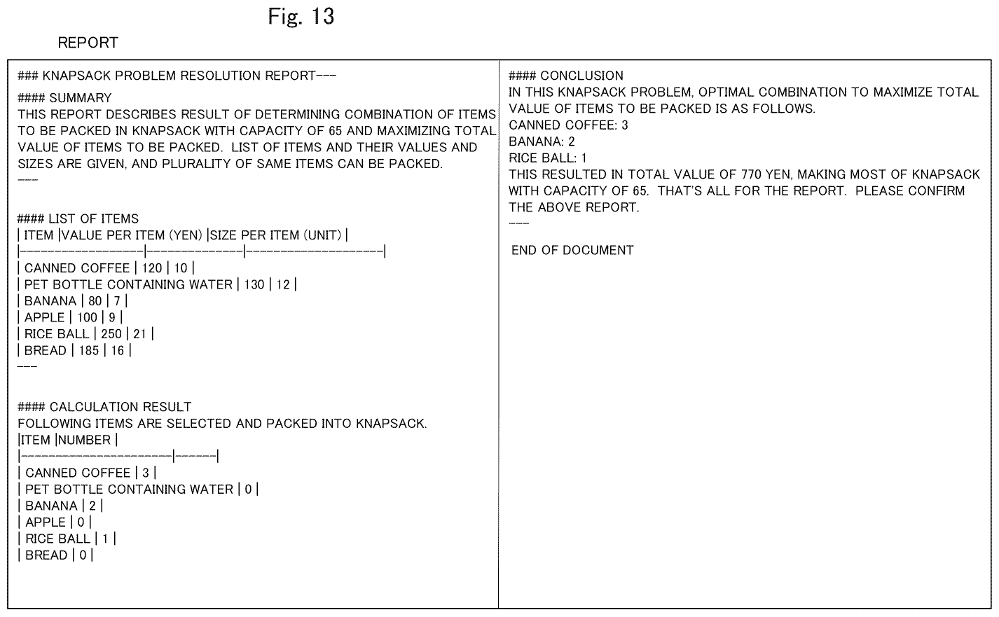

FIG. 12 is an example of the prompt input to the generative AI in the reporting processing unit 47. As illustrated in FIG. 12, a prompt 71 includes a problem background 72, an optimal solution 73 as a program execution result, and an instruction 74 to request creation of a report after presenting a report object. FIG. 13 is an example of an output result of the generative AI in the reporting processing unit 47. As illustrated in FIG. 13, the output result is the report with explanation that can be interpreted by the user according to the instruction of the prompt 71. The output result of the generative AI is transmitted to the user terminal 2 by the information output unit 42 and displayed. As a result, the user can confirm a content of the report. The user may input the additional information from the additional input screen 58 as necessary by, for example, pointing out a part that is difficult to understand, and in this case, the reporting processing unit 47 generates a new report according to the additional information. As a result, the reporting processing unit 47 can generate the report at a level that can be interpreted by the user.

The reporting processing unit 47 may generate, in a case where a report generation request or specification information regarding a format or the like is acquired from the user terminal 2 by a predetermined operation, the report according to the specification information, or may automatically generate the report without acquiring the report generation request in a case where an optimal solution by the program execution unit 46 is acquired. In this case, the user may specify the format in advance, or the format may be changed to the format specified by the user after the report is generated.

In the above configuration, the information input unit 41, the information output unit 42, the problem processing unit 43, the modeling processing unit 44, the coding processing unit 45, the program execution unit 46, and the reporting processing unit 47 of the server 1 are examples of input information acquisition means, output means, problem definition generation means, model construction means, code generation means, program execution means, and report generation means of the present disclosure. The user input information and the related DB 31 are examples of input information and a related information storage unit of the present disclosure.

### (Optimization Processing)

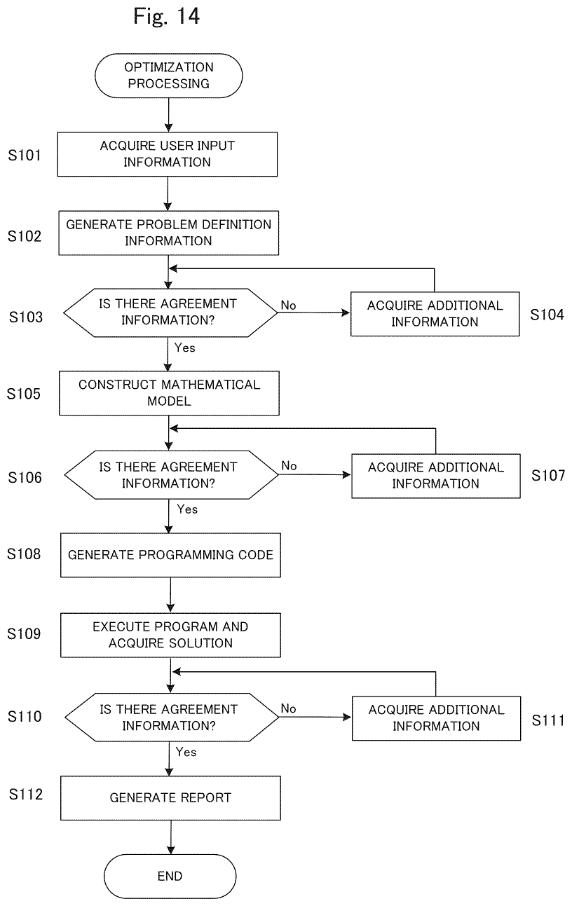

Next, the optimization processing by the server 1 will be described. FIG. 14 is a flowchart of the optimization processing by the server 1. This processing is achieved by the processor 12 illustrated in FIG. 2A executing a program prepared in advance.

First, the server 1 acquires, from the user terminal 2, user input information regarding a problem desired to be solved by a user (step S101). By inputting a prompt to request generation of problem definition information to the generative AI based on the user input information, the server 1 clarifies an object, specifies a variable, and specifies a constraint condition, and generates the problem definition information (step S102). Specifically, the server 1 generates the problem definition information such as the object, a constraint, data, and a decision variable needed for constructing a mathematical model, and transmits the problem definition information to the user terminal 2 as an output result. The user confirms a content of the output result displayed on the user terminal 2, inputs additional information as necessary, and agrees with the content of the output result.

The server 1 determines whether or not agreement information has been acquired from the user terminal 2 (step S103). In a case where the agreement information has not been acquired (step S103; No), the server 1 acquires the additional information, performs processing as necessary, and returns to the processing of step S103 (step S104). On the other hand, in a case where the agreement information has been acquired (step S104; Yes), the server 1 constructs and outputs the mathematical model by inputting a prompt to request formulation of the mathematical model to the generative AI based on the problem definition information and the user input information (step S105). Specifically, the server 1 forms an objective function and converts the constraint condition into a mathematical expression based on the problem definition information and the user input information, formulates the problem into the mathematical model, and transmits the mathematical model to the user terminal 2 as an output result. The user confirms a content of the output result displayed on the user terminal 2, inputs additional information as necessary, and agrees with the content of the output result.

The server 1 determines whether or not agreement information has been acquired from the user terminal 2 (step S106). In a case where the agreement information has not been acquired (step S106; No), the server 1 acquires the additional information, performs processing as necessary, and returns to the processing of step S106 (step S107). On the other hand, in a case where the agreement information has been acquired (step S106; Yes), the server 1 generates and outputs a programming code by inputting a prompt to request conversion into a code to the generative AI based on the problem definition information and the formulated mathematical model (step S108). Next, the server 1 executes a program based on the generated programming code, and acquires a solution as an execution result (step S109). The execution result of the program is transmitted to the user terminal 2. The user confirms an optimal solution of the problem as the execution result of the program displayed on the user terminal 2, inputs additional information as necessary, and agrees with the content of the output result.

The server 1 determines whether or not agreement information has been acquired from the user terminal 2 (step S110). In a case where the agreement information has not been acquired (step S110; No), the server 1 acquires the additional information, performs processing as necessary, and returns to the processing of step S110 (step S111). On the other hand, in a case where the agreement information has been acquired (step S110; Yes), the server 1 generates and outputs a report with explanation that can be interpreted by the user by inputting a prompt to request generation of the report to the generative AI based on the optimal solution and the user input information (step S112). The output result is transmitted to the user terminal 2 by the information output unit 42 and displayed. As a result, the user can confirm a content of the report. In this manner, the server 1 ends the optimization processing.

The optimization system 100 as described above has a wide variety of application domains, and can automate a business process for applying the mathematical optimization. Specifically, the optimization system 100 can automate definition of a problem, construction of a mathematical model, coding of the mathematical model, solving by execution of a program, and reporting of a result. Therefore, it is possible to support a user who does not have specialized knowledge of a domain or knowledge of the mathematical optimization to solve a business problem using the mathematical optimization.

As a result, it is possible to solve a conventional problem that it takes time for each business process that can be performed only by a person having knowledge of a domain and specialized knowledge of the mathematical optimization. It is also possible to make it easier for a person who is not a specialized person to apply the mathematical optimization to business, and to increase the number of persons who can handle the mathematical optimization as the business. Since the number of cases to be processed per person who has originally handled the mathematical optimization can also be increased, it is also possible to promote use of the mathematical optimization in the entire industry.

Specifically, the optimization system 100 can reduce a time needed for manual data processing and analysis, and can speed up a process of the mathematical optimization. As a result, a speed of decision making increases, and an organization can respond quickly to a change in a market and maintain a competitive advantage. By the optimization system 100, it is possible to have an ability to quickly and accurately process a large amount of data. As a result, it is possible to perform decision making based on an analysis result with high accuracy, and an optimal strategy can be prepared while minimizing a risk.

Further, the optimization system 100 can reduce human resources and reduce operation costs in the long term. In particular, automation of repeated tasks and calculation work can reduce human errors, and reallocate labor to more strategic business. By the optimization system 100, a person in charge of the mathematical optimization can reduce a time until solving a business problem and increase the number of problems in charge, and thus can cope with an increase in a scale of business. As a result, application of the mathematical optimization spreads to a market.

The related DB 31 may be shared anonymously among users. As a result, past data can be accumulated for each domain of the mathematical optimization, and business information can be easily collected.

By specifying a domain of a user from user input information or login information related to a predetermined service, the server 1 may refer to information regarding the domain from web information or the like. As a result, the server 1 can increase a resolution when problem definition information is generated.

When the problem definition information is generated, the server 1 may present information regarding an understood business process to a user using, for example, a flowchart or a drawing. As a result, the user can easily confirm a content of an output result.

In a case where there is a missing numerical value when the problem definition information is generated, the server 1 may complement the missing numerical value with a commonsense numerical value to obtain the output result.

The generative AI in construction of a mathematical model may use an LLM specialized in a mathematical expression or may combine a plurality of LLMs.

### [Modification]

In the above example embodiment, a user uses the user terminal 2. However, the present disclosure is not limited to this, and the user may use a user terminal having a function of the server 1. In this case, the user terminal can execute optimization processing performed by the server 1, and can perform generation of problem definition information regarding a problem desired to be solved by the user, construction of a mathematical model, generation of a programming code, execution of a program, and generation of a report.

A part or all of the example embodiments described above may also be described as the following supplementary notes, but not limited thereto.

### (Supplementary Note 1)

An optimization device comprising:
input information acquisition means for acquiring input information regarding a problem input by a user;
code generation means for generating a code based on the input information;
program execution means for executing a program based on the code and acquiring a solution; and
output means for outputting the solution.

### (Supplementary Note 2)

The optimization device according to Supplementary note 1, further comprising
model construction means for constructing a mathematical model based on the input information,
wherein the code generation means generates the code by converting the mathematical model into a code.

### (Supplementary Note 3)

The optimization device according to Supplementary note 2, further comprising
problem definition generation means for generating problem definition information including an object, variable information, and a constraint condition, based on the input information,
wherein the model construction means constructs the mathematical model by forming an objective function for solving the problem and converting the constraint condition into a mathematical expression, based on the problem definition information.

### (Supplementary Note 4)

The optimization device according to Supplementary note 3, further comprising
report generation means for generating a report with explanation interpretable by the user based on the solution and any one or more of the input information, the problem definition information, and the mathematical model,
wherein the output means outputs the report.

### (Supplementary Note 5)

The optimization device according to Supplementary note 3, further comprising
a related information storage unit that stores past input information and problem definition information generated based on the past input information in association with each other,
wherein the problem definition generation means generates the problem definition information with reference to the related information storage unit based on the input information.

### (Supplementary Note 6)

The optimization device according to Supplementary note 3, wherein the model construction means specifies a solution method to the problem based on any one or more of the input information, the problem definition information, and the mathematical model.

### (Supplementary Note 7)

The optimization device according to Supplementary note 3, wherein the program execution means corrects the code or corrects the mathematical model based on any one or more return values of an execution log and code execution when an error is output or a solution is not detected.

### (Supplementary Note 8)

The optimization device according to Supplementary note 4, wherein
the input information acquisition means acquires additional input information regarding the report after the report is output, and
the report generation means generates a new report corrected based on the additional input information.

### (Supplementary Note 9)

The optimization device according to Supplementary note 3, wherein the input information is any one of text, a mathematical expression, a moving image, and audio, or a combination of these.

### (Supplementary Note 10)

The optimization device according to Supplementary note 3, wherein
the problem definition generation means generates the problem definition information by inputting a prompt to request generation of the problem definition information to a generative AI based on the input information,
the model construction means constructs the mathematical model by inputting a prompt to request formulation of the mathematical model to the generative AI based on the problem definition information, and
the code generation means performs the conversion into the code by inputting a prompt to request conversion of the mathematical model into a code to the generative AI.

### (Supplementary Note 11)

An optimization method executed by an optimization device, the optimization method comprising:
acquiring input information regarding a problem input by a user;
generating a code based on the input information;
executing a program based on the code and acquiring a solution; and
outputting the solution.

### (Supplementary Note 12)

A program for causing a computer to execute processing comprising:
acquiring input information regarding a problem input by a user;
generating a code based on the input information;
executing a program based on the code and acquiring a solution; and
outputting the solution.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure. That is, it is a matter of course that the present disclosure includes various modifications and corrections that can be made by those of ordinary skill in the art in accordance with the entire disclosure including the claims and the technical idea.

### DESCRIPTION OF SYMBOLS

1 Server
2 User terminal
11, 21 Interface
12, 22 Processor
13, 23 Memory
14, 24, Recording medium
15, 25 Display unit
16, 26 Input unit
31 Related DB
41 Information input unit
42 Information output unit
43 Problem processing unit
44 Modeling processing unit
45 Coding processing unit
46 Program execution unit
47 Reporting processing unit
48 Search unit
100 Optimization system

1. An optimization device comprising:
a memory configured to store instructions; and
a processor configured to execute the instructions to:
acquire input information regarding a problem input by a user;
generate a code based on the input information;
execute a program based on the code and acquire a solution; and
output the solution.

2. The optimization device according to claim 1,
wherein the processor is further configured to execute the instructions to construct a mathematical model based on the input information, and
wherein the processor generates the code by converting the mathematical model into the code.

3. The optimization device according to claim 2,
wherein the processor is further configured to generate problem definition information including an object, variable information, and a constraint condition, based on the input information, and
wherein the processor constructs the mathematical model by forming an objective function for solving the problem and converting the constraint condition into a mathematical expression, based on the problem definition information.

4. The optimization device according to claim 3,
wherein the processor is further configured to generate a report with explanation interpretable by the user based on the solution and any one or more of the input information, the problem definition information, and the mathematical model, and
wherein the processor outputs the report.

5. The optimization device according to claim 3, further comprising a related information storage that stores past input information and problem definition information generated based on the past input information in association with each other,
wherein the processor generates the problem definition information with reference to the related information storage based on the input information.

6. The optimization device according to claim 3, wherein the processor specifies a solution method to the problem based on any one or more of the input information, the problem definition information, and the mathematical model.

7. The optimization device according to claim 3, wherein the processor corrects the code or corrects the mathematical model based on any one or more return values of an execution log and code execution in a case where an error is output or a solution is not detected.

8. The optimization device according to claim 4,
wherein the processor acquires additional input information regarding the report after the report is output, and
wherein the processor generates a new report corrected based on the additional input information.

9. The optimization device according to claim 3, wherein the input information is any one of text, a mathematical expression, a moving image, and audio, or a combination of these.

10. The optimization device according to claim 3,
wherein the processor generates the problem definition information by inputting a prompt to request generation of the problem definition information to a generative AI based on the input information,
wherein the processor constructs the mathematical model by inputting a prompt to request formulation of the mathematical model to the generative AI based on the problem definition information, and
wherein the processor performs the conversion into the code by inputting a prompt to request conversion of the mathematical model into a code to the generative AI.

11. An optimization method executed by an optimization device, the optimization method comprising:
acquiring input information regarding a problem input by a user;
generating a code based on the input information;
executing a program based on the code and acquiring a solution; and
outputting the solution.

12. A non-transitory computer-readable program for causing a computer to execute processing comprising:
acquiring input information regarding a problem input by a user;
generating a code based on the input information;
executing a program based on the code and acquiring a solution; and
outputting the solution.
